(19) United States
(12) Patent Application Publication
(10) Pub. No.: US 2026/0014843 A1
(43) Pub. Date: Jan. 15, 2026

(54) Car cover plate with fixing piece

(71) Applicant: ZHEJIANG SURPASS AUTO PARTS CO.,LTD., Wenzhou City (CN)

(72) Inventors: Yi Lin, Wenzhou City (CN); Lei Lin, Wenzhou City (CN)

(21) Appl. No.: 19/010,419

(22) Filed: Jan. 6, 2025

(30) Foreign Application Priority Data
Jul. 11, 2024 (CN) 202421644748.0

(51) Int. Cl. B60J 7/19; B60J 7/14

(52) U.S. Cl. CPC B60J 7/198; B60J 7/141

(57) ABSTRACT

The present invention exposes a car cover plate with fixing piece, Includes: cover plate body, rail, lock system and fixing; cover body including: Plate body and hinges, the panel body is connected by several shafts to form the cover plate body; the panel body can be folded along the shafts; the rail, set on the cabin frame, the side stop of the panel body rail; the lock system, mounted on the rail, For fixing the removable cover body to the cabin; the fixing, consisting of: limiting component and locating part, for fixing the cover body to the rail. The limiting component has at least one limiting part and the locating part acts on the limiting part to prevent the limiting component from coming out.

### CROSS-REFERENCE TO RELATED APPLICATIONS

This application claims priority benefits to Chinese Patent Application No. 202421644748.0, filed on Jul. 11, 2024, the contents of which are incorporated herein by reference.

### TECHNICAL AREAS

The present invention relates to the field of automobile parts and specifically to a car cover plate with fixing piece.

### BACKGROUND TECHNOLOGY

Pickup trucks are a common vehicle with saloon-like comfort and power, due to the truck's ability to load and adapt to poor surfaces. Its comprehensive capabilities also make it one of the most common off-road models available today. In order to make the pickup truck can adapt to a more diverse environment, most existing pickup trucks need to be fitted with a cover, the current cover is mostly hard cover, the cover is divided into upright and lying flat, lying flat is the cover can't be opened completely, that is, the last plate body can't be turned over, the whole cover can only be opened two-thirds, it's not convenient to pick and place things. The upright cover can be almost fully opened, but the upright cover is raised when opened, the upright cover needs to be mounted on the front bar, so the connection to the front bar is stable.

Traditional covers are mostly tensioned with the side rails of the cover by the screw, due to the single structure and poor stability at the front bar connection end, the screw is easy to disengage.

### CONTENT OF INVENTION

The embodiment of the present invention provides a car cover plate with fixing piece to at least solve the technical problem that most conventional covers are screw fixing, resulting in poor connection end stability and easy screw release.

For the purpose of achieving the above, the embodiment of the present invention shall adopt the following technical scheme:

A car cover plate with fixing piece, cover body, rail, the lock system and the fixing;

The cover plate body, including: The plate body and the rotating shaft, multiple plate body connected by several rotating shafts to form the cover plate body; the plate body can be folded along the rotating shaft;

The rail, set on the cabin frame, the side of the plate body against the rail;

The lock system, installed in the rail, for the purpose of fixing the cover plate body removable in the compartment;

The fixing, consisting of: The limiting part and the locating part, for fixing the cover body on the rail;

Where the limiting component has at least one limiting part and the locating part acts on the limiting part to prevent the limiting component from disengaging.

Further, the fixing also including: Rail connection block, plate connection block;

The guide rail connector block consists of: The rail slide block, the connection end and the locating hole; the rail slide block mounted on the rail, the limiting component is connected to the plate connection block through the locating hole in the guide rail connector block;

The plate connection block, fitted to the plate body by means of a spout set on the plate body;

The guide rail connector block, with one end mounted on the rail and the other end connected to the cover plate body through the plate connection block;

Where, the plate connection block has a positioning structure, the locating part through the positioning structure acting on the limiting part, to prevent the lifting of the limiting component.

Further, the limiting component including: The limiting part and the connection part, the diameter of the limiting part is less than the maximum diameter of the connection part;

The limiting component are any of the stop bolts, stop screws, stop pins, stop shafts.

Further, the locating part being the R-shaped locating clip which consists of the open end and the closed end, the opening dimension of the closed end is greater than the diameter of the limiting part and less than the maximum diameter of the connecting part;

Where the R-shaped locating clip under external force opens the open end and the limiting component is placed at the closed end limits the removal of the limiting component.

Further, the fixing also consisting of: guide rail connector block, plate connection block, the locating part is the R-shaped locating clip;

The plate connection block is a T-shaped or One-shaped connecting block;

The T-shaped or One-shaped connecting block including: positioning structure, guide groove first hole, threaded hole, and toward the first surface of the guide rail connector block and the second surface away from the guide rail connector block; where, the positioning structure is a locating slot or hole;

The first surface and the second surface are parallel, the first hole is located on the first surface, the threaded hole is located on the second surface, the first hole is coaxial with the threaded hole;

The positioning structure is located between the first hole and the threaded hole through the T-shaped or One-shaped connecting block, the orientation is perpendicular to the first surface normal, and parallel to the guide groove;

The guide groove are installed in the spout of the cover plate body;

Where the limiting component is installed in the first hole and the threaded hole and the limiting part is placed in the positioning structure;

When the open end of the R-shaped locating clip is inserted under external force in the positioning structure, the limiting part is placed in the closed end, the closed end limits the axial displacement of the limiting component, Prevents detachment.

Further, the fixing also consisting of: guide rail connector block, plate connection block, the locating part is the R-shaped locating clip;

The plate connection block is a V-shaped connecting block;

The V-shaped connecting block consists of: Positioning structure, guide groove first slot, threaded hole, and toward the first surface of the guide rail connector block and the second surface away from the guide rail connector block; where, the positioning structure is a locating slot or hole;

The first surface and the second surface are parallel;

The first slot, located on the first surface and through the V-shaped connecting block in the direction of the guide groove; the threaded hole located on the second surface;

The positioning structure through the V-shaped connecting block, the orientation of which is perpendicular to the first surface normal and parallel to the guide groove;

The guide groove is installed in the spout of the cover plate body;

Where the limiting component is mounted in the threaded hole in the direction of the first surface to the second surface and the limiting part is placed in the positioning structure;

When the open end of the R-shaped locating clip is inserted under external force in the detent structure, the limiting part is placed in the closed end, the closed end limits the axial displacement of the limiting component, Prevents detachment.

Further, the fixing also consisting of: guide rail connector block, plate connection block, the locating part is the R-shaped locating clip;

The plate connection block is a gap type connecting block;

The gap type connecting block consists of: Positioning structure, guide groove, second hole, threaded hole, and toward the first surface of the guide rail connector block and the second surface away from the guide rail connector block, where the positioning structure is the clearance between the plate connection block and the plate body, and that the R-shaped locating clip is capable of passing through the gap of the position structure;

The first surface and the second surface are parallel, the second hole is located on the first surface, the threaded hole is located on the second surface, the second hole is coaxial with the threaded hole;

The guide groove is installed in the spout of the cover plate body;

Where the limiting component is installed in the second hole and the threaded hole and the limiting part is located in the gap between the plate connection block and the plate body;

When the open end of the R-shaped locating clip is inserted by an external force between the plate connection block and the plate body, the limiting part is placed at the closed end, the closed end limits the axial displacement of the limiting component to prevent ejection.

Further, the fixing also includes: guide rail connector block and plate connection block;

The guide rail connector block consists of: Rail slide block, connection end, locating hole, flank set on both sides of the locating hole, a groove parallel to the rail slider; the rail slider is mounted on the rail and the limiting component is connected to the plate body connector block through the locating hole on the guide rail connector block;

The plate connection block consists of: The threaded hole, the first surface toward the guide rail connector block and the raised end at the first surface, the installation position;

The locating part is the locating block, the locating block consists of: The U-shaped extension end, the first threaded hole located at the top of the locating block, the first bolt and the end of the slide end located at the bottom of the 1 locating block; the end of the slide end is mounted in the spout of the cover plate body;

In combination with the locating block), the guide rail connector block and the plate connection block, the raised end is inserted into the groove; the flank is fitted with the installation position for stop fixing; and the limiting component is connected through the locating hole to the threaded hole, the limiting part of the limiting component is located between the flank and the installation position. the U-shaped extension end of the locating block inserted between the flank and the installation position and the limiting part, which can be secured by the first threaded hole and the first bolt, limit the axial displacement of the limiting component, Prevents detachment.

Further, the plate body consists of: The front bar and the rear bar;

The front bar, which can be disassembled and attached to the rail by means of the fixing;

The rear bar, which can be connected to the cabin by means of the lock system;

The car cover plate with fixing piece also includes: support system;

The support system, with one end connected to the cover plate body and the other end connected to the vehicle compartment or body, used to support the cover plate body when the cover is opened.

Further, the plate connection block, through a spout set on the plate body, Fitted in the front bar.

### Beneficial Effect of the Invention:

1. The car cover plate with fixing piece provided by the embodiment of the present invention, which is connected to the cover by means of fixing (limiting component and locating part), instead of conventional screw, is effective in improving the stability of the connection of the cover, it also avoids the problem of traditional screw connection easily come out, poor stability.
2.The car cover plate with the fixing piece provided by the embodiment of the present invention shall prevent the removal of the limiting component by designing the fixing as: A limiting component and a locating part, with at least one limiting part on the limiting component, and by the interaction of the locating part and the limiting component. This effectively avoids the release of the fixing after the cover has been fitted, improving the stability of the connection end of the entire cover.

### SEE ILLUSTRATION

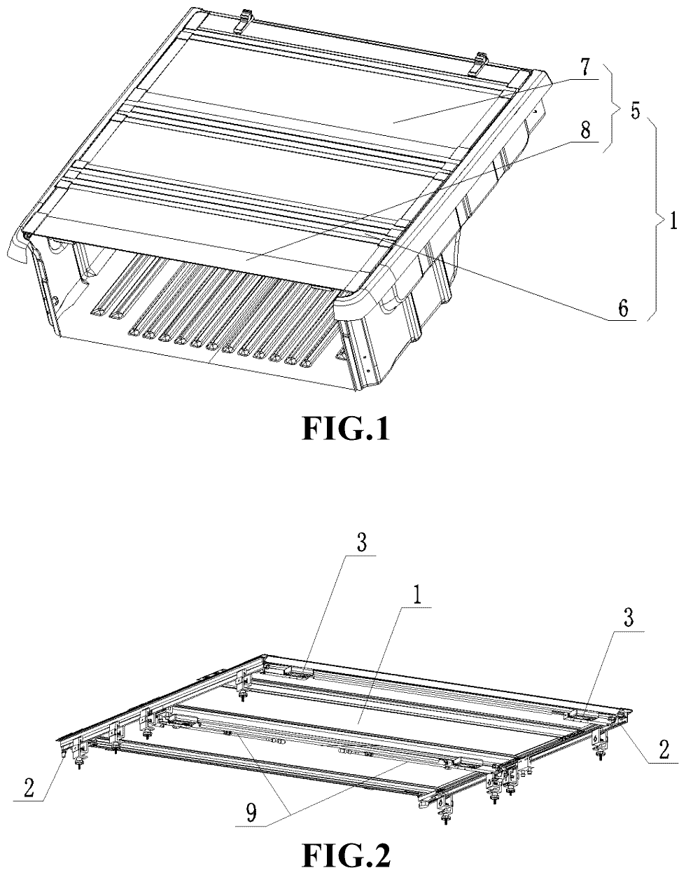

FIG. 1 shows one of the schematic diagrams of the structure of a car cover plate with fixing piece member provided by the present invention;

FIG. 2 shows a schematic diagram of a structure of a car cover plate with fixing piece member provided by the present invention in one of the schematic diagrams;

FIG. 3 shows a schematic diagram of a structure of a car cover plate with fixing piece member provided by the present invention;

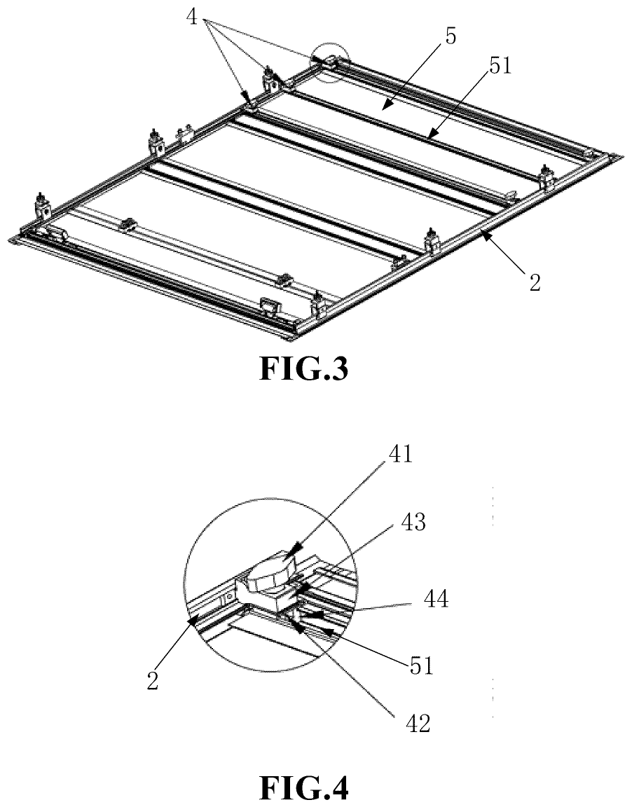

FIG. 4 shows one of the partial installation diagrams of the fixing member provided by the present invention;

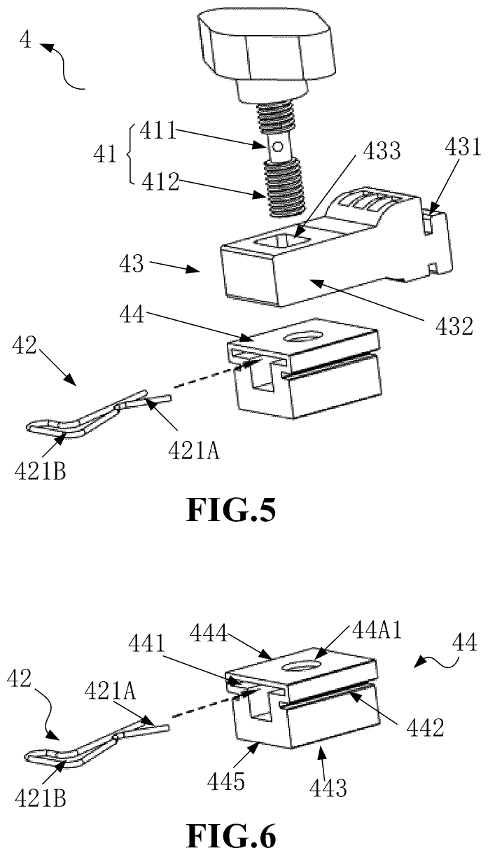

FIG. 5 shows one of the exploded schematic diagrams of the fixing member provided by the present invention;

FIG. 6 shows one of the exploded schematic diagrams of the fixing member provided by the present invention;

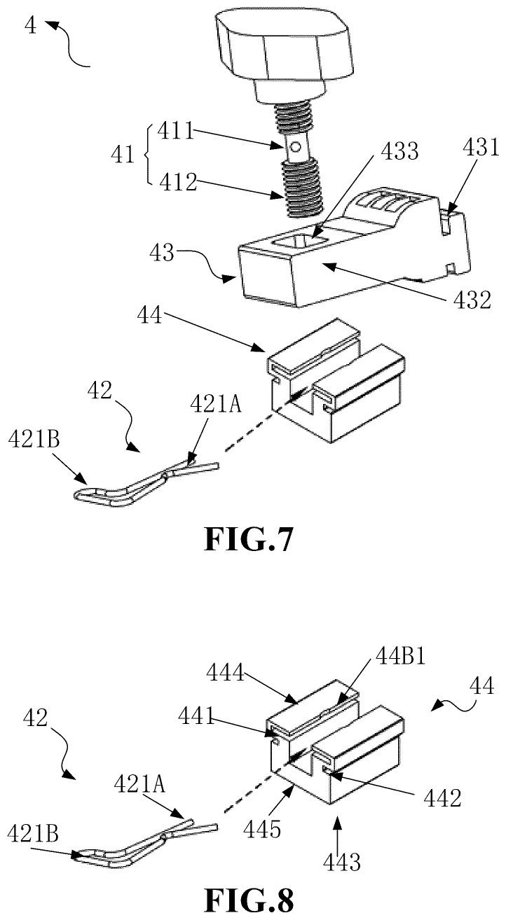

FIG. 7 shows one of the exploded schematic diagrams of the fixing member provided by the present invention;

FIG. 8 shows an exploded schematic diagram of a fixing member provided by the present invention;

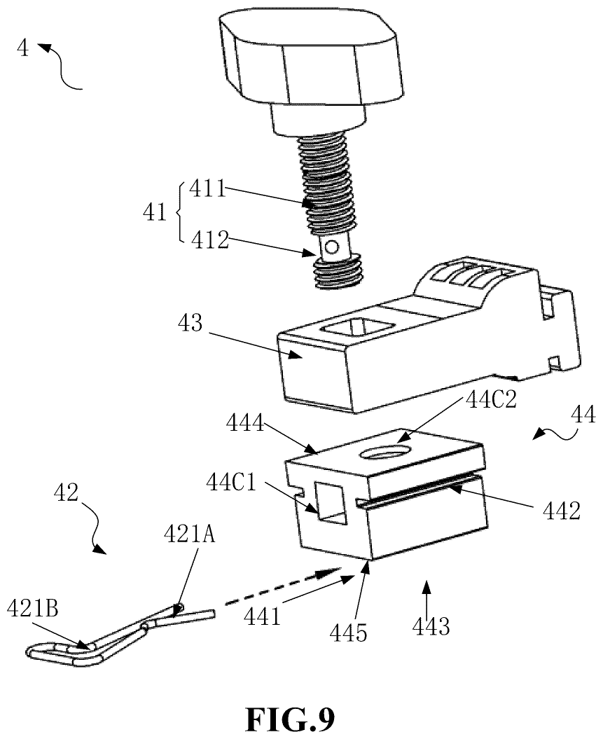

FIG. 9 shows an exploded schematic diagram of a fixing member provided by the present invention v;

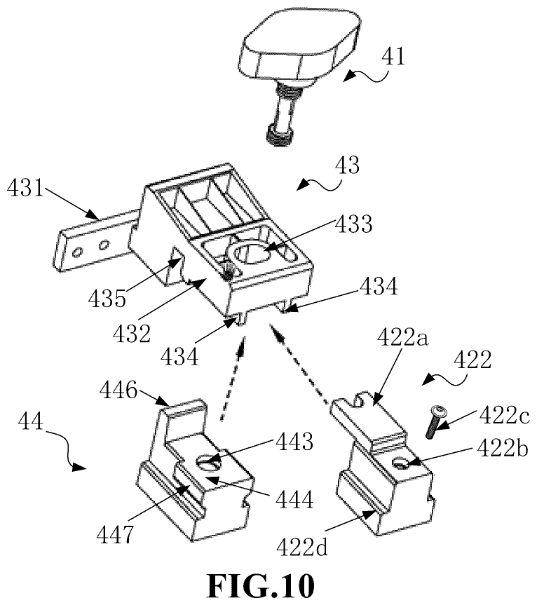

FIG. 10 shows an exploded schematic diagram of a fixing member provided by the present invention VI;

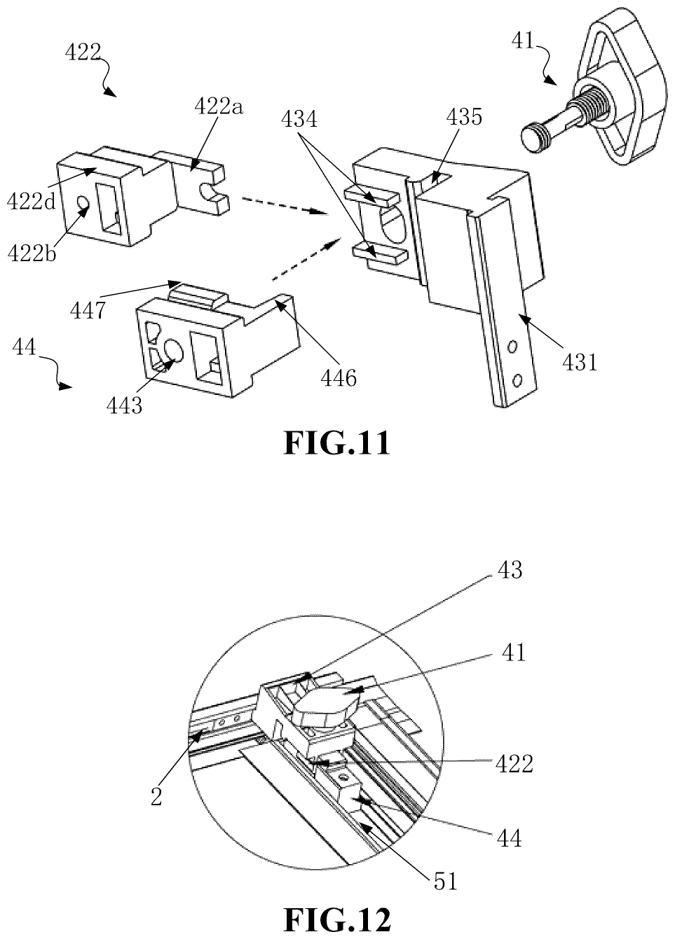

FIG. 11 shows an exploded schematic diagram of a fixing member provided by the present invention, seventh;

FIG. 12 shows another partial installation diagram of the fixing member provided by the present invention.

In the Figure:
1. cover plate body, 2—rail, 3—lock system, 4—fixing, 41—limiting component, 411—limiting part, 412—connection part, 42—locating part, 421—R-shaped locating clip, 421A—open end, 421B—closed end, 422—locating block, 422a—U-shaped extension end, 422b—first threaded hole, 422c—First bolt, 422d—slide end, 43—guide rail connector block, 431—rail slide block, 432—connection end, 433—locating hole, 434—wing, 435—groove, 44—plate connection block, 441—positioning structure, 442—guide groove, 443—threaded hole, 444—first surface, 445—second surface, 446—raised end, 447—installation position, 44A—T-shaped or One-shaped connecting block, 44A1—first hole, 44B—V-shaped connecting block, 44B1—first slot, 434—flank, 44C—gap type connecting block, 44C1—square through hole, 44C2—second hole, 5—plate body, 51—spout, 6—rotating shaft, 7—front bar, 8—rear bar, 9—support system.

### Specific Implementation Modalities

The embodiments of the invention are described in detail below in conjunction with the accompanying drawings.

In the description of the invention it is to be understood that the terms “center”, “top”, “Down”, “Front”, “Rear”, “Left”, Right, Vertical, Horizontal, top, the orientation or location relationship indicated by the “bottom”, “inside”, “outside” etc. is based on the orientation or location relationship shown in the attached diagram, solely for the purpose of facilitating the description of the invention and the simplified description, without indicating or implying that the device or component in question must have a particular orientation, be constructed and operated in a particular orientation, and therefore cannot be understood as a limitation of the invention.

In the description of the invention it is necessary to state that, unless otherwise expressly stated and qualified, the term “installation”, “Connected”, “Connected” should be understood in a broad sense, for example, it can be a fixed connection, It can be a detachable connection, or a one-piece connection; it can be a mechanical or electrical connection; it can be a direct connection, or it can be connected indirectly through an intermediate medium, this can be a continuity within the two elements. For the general technician in this field, the specific meaning of the above term in the present invention may be understood in the specific case.

The invention is intended to solve the problem of the screw fixing of the traditional cover, which results in poor stability of the connection end and easy removal of the screw. Creative proposal of a car cover plate with fixing piece that prevent the removal of a limiting component and a locating part, with at least one limiting part on the limiting component, and by the interaction of the locating part and the limiting component. This effectively avoids the release of the fixing after the cover has been fitted, improving the stability of the connection end of the entire cover.

A cover plate body with fixing piece provided by embodiment of the present invention as shown in FIG. 1, FIG. 2, including: cover body (1), rail (2), the lock system (3) and the fixing (4);

The cover plate body (1), including: The plate body (5) and the rotating shaft (6), multiple plate body (5) connected by several rotating shafts (6) to form the cover plate body (1); the plate body (5) can be folded along the rotating shaft (6);

The rail (2), set on the cabin frame, the side of the plate body (5) against the rail (2);

The lock system (3), installed in the rail (2), for the purpose of fixing the cover plate body (1) removable in the compartment;

The fixing (4), consisting of: The limiting part (41) and the locating part (42), for fixing the cover body (1) on the rail (2);

Where the limiting component (41) has at least one limiting part (411) and the locating part (42) acts on the limiting part (411) to prevent the limiting component (41) from disengaging.

Optional, as shown in FIG. 1, FIG. 2, plate body 5 above consists of: front bar 7 and rear bar 8. The front bar 7, which can be attached to the rail 2 by fixing 4, and the rear bar 8, which can be attached to the cabin by lock system 3.

The car cover plate with the fixing provided by the embodiment of the present invention also includes, as shown in FIG. 2, the support system 9. The support system 9, with one end attached to the cover plate body 1 and the other end attached to the cabin or body, supports the cover body 1 when the cover is opened.

Optional, combined with FIG. 1, FIG. 2, as shown in FIG. 3 and FIG. 4, the plate connection block 44, which can be mounted on the front bar 7 by means of a spout 51 set on the plate body 5.

Optional, in combination with FIG. 3, as shown in FIGS. 4 and 5, the limiting component 41 consists of: Stop 411 and connection part 412. The diameter of limiting part 411 is less than the maximum diameter of connection part 412.

Optional, limiting component 41 can be: Stop bolts, stop screws, stop pins, Any of the stops.

The limiting part 411 is used for the stop in conjunction with the locating part 42. The diameter of the limiting part 411 is smaller than the maximum diameter of the connection part 412 in order to allow it to catch when acting on the locating part 42 and prevent it from falling off.

For example, the limiting component 41 stop bolt, the break step position of the limiting part 411 stop bolt, and the studs at both ends of the connection part 412 stop bolt are shown in FIG. 5. The break step of the stop bolt is used in conjunction with the locating part “R” type retaining clip. When used, the “R” type detent clip is further forced into the stop bolt's break step position, because the stop bolt's break step position is smaller in diameter than the maximum diameter of the connection part 412 at both ends, the “R” type retaining clip can be held in this position to prevent the stop bolt from falling off.

It should be noted that the limiting component 41 has at least one limiting part 411. That is, the 1 limiting part 411 can be more than one. At this point, the limits can be carried out using at least one of the limiting part 411, depending on the actual need.

Optional, in combination with FIG. 3, as shown in FIG. 4 and FIG. 5, FIG. 4 is a detail magnification view of FIG. 3. FIG. 5 shows an exploded diagram of the fixing 4. The fixing 4 also includes: guide rail connector block 43, plate connection block 44. The guide rail connector block 43 consists of: Rail slide 431, connection end 432, and locating hole 433; rail slide 431 is mounted on rail 2, and the limiting component 41 is attached to the plate connection block 44 through the locating hole 433 on the guide rail connector block 43. The plate connection block 44 is fitted to the plate body 5 by means of a spout 51 set on the plate body 5. The guide rail connector block 43, mounted on the rail 2 at one end and connected to the cover body 1 by the plate body connection block 44 at the other end. Among them, the plate connection block 44 has a positioning structure 441, the locating part 42 through the positioning structure 441 acting on the limiting part 411, to prevent the limiting part 41 from coming out.

It is important to note that since the locating part 42 has two forms: R-shaped locating clip 421 and locating block 422, the corresponding fixing 4 has two implementation methods, which are explained below.

### First: The R-Shaped Locating Clip 421 for the Locating Part.

As shown in FIG. 5, the R-shaped locating clip 421 above consists of: Open end 421A and closed end 421B, the open size of the closed end 421B is larger than the diameter of the limiting part 411 and smaller than the maximum diameter of the connection part 412. Where the R-shaped locating clip 42 is forced to open the open end 421A and the limiting component 41 is placed in the closed end 421B limiting the removal of the limiting component 41.

It is to be noted that the locating part for the fixing 4 embodiment of the R-shaped locating clip 421, the combination can be broken down into three specific implementation methods, as described below to implement mode one, 2. III is described separately.

### Implementation Mode I

In conjunction with FIGS. 1 to 4, as shown in FIGS. 5 and 6, the fixing 4 also include: guide rail connector block 43, plate connection block 44, the locating part 42 is an R-shaped locating clip 421. The plate block 44 is a T-shaped or One-shaped connecting block 44A.

T-shaped or One-shaped connecting block 44A includes: Positioning structure 441, guide groove 442, first hole 44A1, threaded hole 443, and toward the first surface 444 of the guide rail connection block 43 and the second surface 445 of the guide rail connection block 43; where the positioning structure 441 is a locating slot or hole.

It should be noted that the and cross-sections of the T-shaped or One-shaped connecting block of their locating slots or holes (i.e. positioning structure 441) are in the “T” or “One” type.

The first surface 444 is parallel to the second surface 445, the first hole 44A1 is on the first surface 444, the threaded hole 443 is on the second surface 445, and the first hole 44A1 is coaxial with the threaded hole 443. FIGS. 5 and 6 Since the threaded hole 443 is not shown in the angular mask, the threaded hole 443 is coaxial to the first hole 44A1 and placed on the second surface 445, and can be blind or through as required.

The positioning structure 441 runs through the T-shaped or One-shaped connecting block 44A, between the first hole 44A1 and the threaded hole 443, and is oriented normal to the first surface 444 and parallel to the guide groove 442. The guide groove 442 is fitted to the spout 51 of the cover plate body 1; the limiting component 41 is fitted in the first hole 44A1 and the threaded hole 443 and the limiting part 411 is placed in the positioning structure 441.

When the open end 421A of the R-shaped locating clip 421 is inserted into the positioning structure 441 by external force, the limiting part 411 is placed in the closed end 421B and the closed end 421B limits the axial displacement of the limiting component 41 to prevent ejection.

### Implementation Mode II

In conjunction with FIGS. 1 to 4, as shown in FIGS. 7 and 8, the fixings 4 also include: guide rail connector block 43, plate connection block 44, the locating part 42 is the R-shaped locating clip 421; the plate connection block 44 is the V-shaped connecting block 44B.

V-shaped connecting block 44B includes: positioning structure 441, guide groove 442, first slot 44B1, threaded hole 443, and toward the first surface 444 of the guide rail connection block 43 and the second surface 445 of the guide rail connection block 43; where the positioning structure 441 is a locating slot or hole.

It should be noted that the and sections of the V-shaped connecting block with its locating slots or holes (i.e. positioning structure 441) are in the “V” or “Y” type.

The first surface 444 is parallel to the second surface 445; the first slot 44B1 is located on the first surface 444 and runs through the V-shaped connecting block 44B in the direction of the guide groove 442; the threaded hole 443 is located on the second surface 445. The positioning structure 441 goes through the V-shaped connecting block 44B and is oriented perpendicular to the first surface 444 normal and parallel to the guide groove 442. The guide groove 442 is fitted to the spout 51 of the cover body 1. The limiting component 41 is mounted in the threaded hole 443 in the direction of the first surface 444 to the second surface 445 and the limiting part 411 is placed in the positioning structure 441.

When the open end 421A of the R-shaped locating clip 421 is inserted into the positioning structure 441 by external force, the limiting part 411 is placed in the closed end 421B and the closed end 421B limits the axial displacement of the limiting component 41 to prevent ejection.

It is important to note that the threaded hole 443 is not shown in FIGS. 7 and 8 because of the angle shading, which can be blind or through as per actual demand. The first slot 44B1, located on the first surface 444, can be spot facing in the middle of the first slot 44B1 for the convenience of mounting the limiting component 41.

### Implementation Mode III

In conjunction with FIGS. 1 to 4, as shown in FIG. 9, the fixing 4 also include: guide rail connector block 43, plate connection block 44; the locating part 42 is the R-shaped locating clip 421; the plate connection block 44 is the gap type connecting block 44C.

Gap type connecting block 44C includes: positioning structure 441, guide groove 442, second hole 44C2, threaded hole 443, and toward the first surface 444 of the guide rail connection block 43 and the second surface 445 away from the guide rail connector block 43; where the positioning structure 441 is the clearance between the plate connection block 44 and the plate body 5, and the R-shaped locating clip 421 is able to pass the clearance of the positioning structure 441.

The first surface 444 is parallel to the second surface 445, the second hole 44C2 is located on the first surface 444, the threaded hole 443 is located on the second surface 445 and the second hole 44C2 is coaxial with the threaded hole 443; the guide groove 442 is fitted to the spout 51 of the cover plate body 1. Where the limiting component 41 is fitted in the second hole 44C2 and the threaded hole 443 and the limiting part 411 is located in the clearance between the plate connection block 44 and the plate body 5.

When the open end 421A of the R-shaped locating clip 421 is inserted by external force between the plate connection block 44 and the plate body 5, the limiting part 411 is placed in the closed end 421B, the closed end 421B limits the axial displacement of the limiting component 41 to prevent ejection.

The optional, gap type connecting block 44C can also include: Square through hole 44C1, which is located perpendicular to the first surface 444 normal. and parallel to the guide groove 442. Normally it is possible to set the square through hole 44C1 without setting it.

### Second: The Locating Part is the Locating Block 422.

Combine FIGS. 1 to 4, as shown in FIGS. 10, 11 and 12, where, FIG. 10 and FIG. 11 show the exploded fitting of the locating part with the locating block 422 and FIG. 12 shows the fitting of the locating part with the locating block 422. The fixing 4 also includes: guide rail connector block 43 and plate connection block 44. The guide rail connector block 43 consists of: Rail slide block 431, connection end 432, locating hole 433, flank 434 set on both sides of the locating hole 433, the groove 435 parallel to the rail slide 431; the rail slide 431 is mounted on rail 2 and the limiting component 41 is attached to the plate connection block 44 through the locating hole 433 on the guide rail connector block 43.

The plate connection block 44 consists of the threaded hole 443, the first surface 444 toward the guide rail connection block 43, and the raised end 446 at the first surface 444, the installation position 447.

The locating part 42 is the locating block 422, locating block 422 consists of: U-shaped extension end 422a, first threaded hole 422b at the top of locating block 422, first bolt 422c and slide end 422d at the bottom of locating block 422; slide end 422d fitted to the spout 51 of cover plate body 1.

Locating block 422, guide rail connector block 43 and plate connection block 44 are used with raised end 446 in groove 435, flank 434 is held in stop with installation position 447, when limiting component 41 is connected through the threaded hole 443 through the locating hole 433. The limiting part 411 of the limiting component 41 is located between the flank 434 and the installation position 447. The U-shaped extension end 422a of the locating block 422 is inserted between the flank 434 and the installation position 447 and the limiting part 411, which can be fixed by the first threaded hole 422b and the first bolt 422c, limiting the axial displacement of the limiting part 41. Prevents detachment.

It is important to note that the dotted arrows in all attached drawings are used to indicate the insertion direction and installation location of the part, i.e. installation in the direction of the dotted arrows.

It will be understood that that car cover plate with fixing provided by embodiment of the present invention, which is connected to the cover by means of fixing (limiting component and locating part), by design of fixing as: limiting component and locating part, At least one limiting part is set on the limiting component and the limiting part is prevented from disengaging by locating part and the action of the limiting component. This effectively avoids the release of the fixing after the cover has been fitted, improving the stability of the connection end of the entire cover.

In the description of this instruction sheet, specific features, structures, or features may be combined in any one or more embodiments or examples in a suitable manner.

The above is only a specific implementation of the invention, but the scope of protection of the invention is not limited to this, and any technical person familiar with the technical field, within the scope of the technology disclosed in the invention, a change or replacement which can easily be contemplated shall be covered by the protection of the invention. Accordingly, the scope of protection of the invention shall be governed by the scope of protection of the claim.

1. A car cover plate with fixing piece that is characterized by: cover body (1), rail (2), the lock system (3) and the fixing (4);
The cover plate body (1), including: The plate body (5) and the rotating shaft (6), multiple plate body (5) connected by several rotating shafts (6) to form the cover plate body (1); the plate body (5) can be folded along the rotating shaft (6);
The rail (2), set on the cabin frame, the side of the plate body (5) against the rail (2);
The lock system (3), installed in the rail (2), for the purpose of fixing the cover plate body (1) removable in the compartment;
The fixing (4), consisting of: The limiting part (41) and the locating part (42), for fixing the cover body (1) on the rail (2);
Where the limiting component (41) has at least one limiting part (411) and the locating part (42) acts on the limiting part (411) to prevent the limiting component (41) from disengaging.

2. The car cover plate with fixing piece according to claim 1, the characteristics of the fixing (4) also include: Rail connection block (43), plate connection block (44);
The guide rail connector block (43) consists of: The rail slide block (431), the connection end (432) and the locating hole (433); the rail slide block (431) mounted on the rail (2), the limiting component (41) is connected to the plate connection block (44) through the locating hole (433) in the guide rail connector block (43);
The plate connection block (44), fitted to the plate body (5) by means of a spout (51) set on the plate body (5);
The guide rail connector block (43), with one end mounted on the rail (2) and the other end connected to the cover plate body (1) through the plate connection block (44);
Where, the plate connection block (44) has a positioning structure (441), the locating part (42) through the positioning structure (441) acting on the limiting part (411), to prevent the lifting of the limiting component (41).

3. The car cover plate with the fixing according to claim 1, which is characterized by the limiting component (41) including: The limiting part (411) and the connection part (412), the diameter of the limiting part (411) is less than the maximum diameter of the connection part (412);
The limiting component (41) are any of the stop bolts, stop screws, stop pins, stop shafts.

4. The car cover plate with fixing piece specified in claim 1 is characterized by the locating part (42) being the R-shaped locating clip (421) which consists of the open end (421A) and the closed end (421B), the opening dimension of the closed end (421B) is greater than the diameter of the limiting part (411) and less than the maximum diameter of the connecting part (412);
Where the R-shaped locating clip (421) under external force opens the open end (421A) and the limiting component (41) is placed at the closed end (421B) limits the removal of the limiting component (41).

5. The car cover plate with fixing piece specified in claim 4 is characterized by the fixing (4) also consisting of: guide rail connector block (43), plate connection block (44), the locating part (42) is the R-shaped locating clip (421);
The plate connection block (44) is a T-shaped or One-shaped connecting block (44A);
The T-shaped or One-shaped connecting block (44A) includes: positioning structure (441), guide groove (442) first hole (44A1), threaded hole (443), and toward the first surface (444) of the guide rail connector block (43) and the second surface (445) away from the guide rail connector block (43); where, the positioning structure (441) is a locating slot or hole;
The first surface (444) and the second surface (445) are parallel, the first hole (44A1) is located on the first surface (444), the threaded hole (443) is located on the second surface (445), the first hole (44A1) is coaxial with the threaded hole (443);
The positioning structure (441) is located between the first hole (44A1) and the threaded hole (443) through the T-shaped or One-shaped connecting block (44A), the orientation is perpendicular to the first surface (444) normal, and parallel to the guide groove (442);
The guide groove (442) are installed in the spout (51) of the cover plate body (1);
Where the limiting component (41) is installed in the first hole (44A1) and the threaded hole (443) and the limiting part (411) is placed in the positioning structure (441);
When the open end (421A) of the R-shaped locating clip (421) is inserted under external force in the positioning structure (441), the limiting part (411) is placed in the closed end (421B), the closed end (421B) limits the axial displacement of the limiting component (41), Prevents detachment.

6. The car cover plate with fixing piece specified in claim 4 is characterized by the fixing (4) also consisting of: guide rail connector block (43), plate connection block (44), the locating part (42) is the R-shaped locating clip (421);
The plate connection block (44) is a V-shaped connecting block (44B);
The V-shaped connecting block (44B) consists of: Positioning structure (441), guide groove (442) first slot (44B1), threaded hole (443), and toward the first surface (444) of the guide rail connector block (43) and the second surface (445) away from the guide rail connector block (43);
where, the positioning structure (441) is a locating slot or hole;
The first surface (444) and the second surface (445) are parallel;
The first slot (44B1), located on the first surface (444) and through the V-shaped connecting block (44B) in the direction of the guide groove (442); the threaded hole (443) located on the second surface (445);
The positioning structure (441) through the V-shaped connecting block (44B), the orientation of which is perpendicular to the first surface (444) normal and parallel to the guide groove (442);
The guide groove (442) are installed in the spout (51) of the cover plate body (1);
Where the limiting component (41) is mounted in the threaded hole (443) in the direction of the first surface (444) to the second surface (445) and the limiting part (411) is placed in the positioning structure (441);
When the open end (421A) of the R-shaped locating clip (421) is inserted under external force in the detent structure (441), the limiting part (411) is placed in the closed end (421B), the closed end (421B) limits the axial displacement of the limiting component (41), Prevents detachment.

7. The car cover plate with fixing piece specified in claim 4 is characterized by the fixing (4) also consisting of: guide rail connector block (43), plate connection block (44), the locating part (42) is the R-shaped locating clip (421);
The plate connection block (44) is a gap type connecting block (44C);
The gap type connecting block (44C) consists of: Positioning structure (441), guide groove (442), second hole (44C2), threaded hole (443), and toward the first surface (444) of the guide rail connector block (43) and the second surface (445) away from the guide rail connector block (43), where the positioning structure (441) is the clearance between the plate connection block (44) and the plate body (5), and that the R-shaped locating clip (421) is capable of passing through the gap of the position structure (441);
The first surface (444) and the second surface (445) are parallel, the second hole (44C2) is located on the first surface (444), the threaded hole (443) is located on the second surface (445), the second hole (44C2) is coaxial with the threaded hole (443);
The guide groove (442) are installed in the spout (51) of the cover plate body (1);
Where the limiting component (41) is installed in the second hole (44C2) and the threaded hole (443) and the limiting part (411) is located in the gap between the plate connection block (44) and the plate body (5);
When the open end (421A) of the R-shaped locating clip (421) is inserted by an external force between the plate connection block (44) and the plate body (5), the limiting part (411) is placed at the closed end (421B), the closed end (421B) limits the axial displacement of the limiting component (41) to prevent ejection.

8. The car cover plate with fixing piece as described in claim 1 is characterized by:
The fixing (4) also includes: guide rail connector block (43) and plate connection block (44);
The guide rail connector block (43) consists of: Rail slide block (431), connection end (432), locating hole (433), flank (434) set on both sides of the locating hole (433), a groove (435) parallel to the rail slider (431); the rail slider (431) is mounted on the rail (2) and the limiting component (41) is connected to the plate body connector block (44) through the locating hole (433) on the guide rail connector block (43);
The plate connection block (44) consists of: The threaded hole (443), the first surface (444) toward the guide rail connector block (43) and the raised end (446) at the first surface (444), the installation position (447);
The locating part (42) is the locating block (422), the locating block (422) consists of: The U-shaped extension end (422a), the first threaded hole (422b) located at the top of the locating block (422), the first bolt (422c) and the end of the slide end (422d) located at the bottom of the 1 locating block (422); the end of the slide end (422d) is mounted in the spout (51) of the cover plate body (1);
In combination with the locating block (422), the guide rail connector block (43) and the plate connection block (44), the raised end (446) is inserted into the groove (435); the flank (434) is fitted with the installation position (447) for stop fixing; and the limiting component (41) is connected through the locating hole (433) to the threaded hole (443), the limiting part (411) of the limiting component (41) is located between the flank (434) and the installation position (447). the U-shaped extension end (422a) of the locating block (422) inserted between the flank (434) and the installation position (447) and the limiting part (411), which can be secured by the first threaded hole (422b) and the first bolt (422c), limit the axial displacement of the limiting component (41), Prevents detachment.

9. A car cover plate with fixing piece, as described of the claim 1, is characterized by:
The plate body (5) consists of: The front bar (7) and the rear bar (8);
The front bar (7), which can be disassembled and attached to the rail (2) by means of the fixing (4);
The rear bar (8), which can be connected to the cabin by means of the lock system (3);
The car cover plate with fixing piece also includes: support system (9);
The support system (9), with one end connected to the cover plate body (1) and the other end connected to the vehicle compartment or body, used to support the cover plate body (1) when the cover is opened.

10. The car cover plate with fixing piece specified in claim 9 is characterized by the plate connection block (44), through a spout (51) set on the plate body (5), Fitted in the front bar (7).
